(19) United States
(12) Patent Application Publication
(10) Pub. No.: US 2018/0218097 A1
(43) Pub. Date: Aug. 2, 2018

(54) MODELING METHOD AND SYSTEM FOR DIODE CLAMPED CASCADED MULTI-LEVEL CONVERTER

(71) Applicants: ELECTRIC POWER RESEARCH INSTITUTE. CHINA SOUTHERN, Guangdong (CN); POWER GRID TECHNOLOGY RESEARCH CENTER, CHINA SOUTHERN POWER GRID, Guangzhou, Guangdong (CN)

(72) Inventors: Yuebin Zhou, Guangdong (CN); Hong Rao, Guangdong (CN); Shukai Xu, Guangdong (CN); Xiaolin Li, Guangdong (CN); Ying Huang, Guangzhou (CN)

(73) Assignee: ELECTRIC POWER RESEARCH INSTITUTE. CHINA SOUTHERN, Guangdong (CN)

(21) Appl. No.: 15/736,656

(22) PCT Filed: Feb. 4, 2016
(86) PCT No.: PCT/CN16/73510

§ 371 Date: Dec. 14, 2017

(30) Foreign Application Priority Data
Sep. 10, 2015 (CN) 201510574892.0

(51) Int. Cl. G06F 17/50; H02M 7/483; H02M 7/5387

(52) U.S. Cl. CPC G06F 17/5009; H02M 7/5387; H02M 7/483

(57) ABSTRACT

A modeling method and system for a diode clamped cascaded multi-level converter. All corresponding diodes of each bridge arm are equivalent to an auxiliary diode; all corresponding capacitors of each bridge arm are equivalent to a controlled voltage source; and power modules of each bridge arm are connected in series to be equivalent to an equivalent module, the equivalent module comprising a loss resistor and a composite equivalent model connected to the loss resistor. Since a plurality of components, at the same positions, in each power module of each bridge arm of the diode clamped cascaded multi-level converter are equivalent to a component, the node voltage equation order can be reduced, the simulation efficiency is improved, and the simulation efficiency cannot be reduced with the increase in the number of power modules. By means of modeling according to the modeling method and system, the demands for VSC-HVDC engineering parameter design, control strategy verification and the like of a long-distance, high-capacity and overhead line occasion can be satisfied.

### FIELD

The present disclosure relates to the field of power electronic technology and voltage sourced converter based high voltage direct current transmission (VSC-HVDC), and more particularly, to a modeling method and system for a diode clamped cascaded multi-level converter.

### BACKGROUND

The diode clamped cascaded multi-level converter has a self-cleaning capability for DC fault, and has same advantages as a half-bridge cascaded multi-level converter, for example, it has a low harmonic content and can be easily extended. Therefore, it is applicable to the VSC-HVDC involved a long-distance, high capacity and overhead line.

Each bridge arm of the cascaded multi-level converter is made up of a large number of power modules required to be controlled independently. When an electromagnetic transient is modeled and simulated with a PSCAD (Power System Computer Aided Design, which is a graphical user interface of an Electro Magnetic Transient in DC System (EMTDC))/EMTDC (which is a power system simulation and analysis software), actions of each power module is needed to be simulated accurately. A traditional way is to use device models provided by a component library of the PSCAD/EMTDC, and to establish a simulation model of the cascaded multi-level converter. When the number of the power modules is few, the simulation efficiency may be acceptable, but will be sharply reduced in the wake of the increasing of the power modules. In particular, when there are hundreds or thousands of the power modules, the simulation efficiency may not satisfy requirements of engineering research and development. Hence, in order to improve the simulation efficiency, many simulation modules of the cascaded multi-level converter for different simulation situations have been developed. However, these simulation modules are generally directed to a half-bridge or full-bridge cascaded multi-level converter only. There is no high-efficiency simulation module directed to the diode clamped cascaded multi-level converter. The existing simulation modules cannot satisfy the requirements on engineering parameter design and control strategy validation of the VSC-HVDC involved a long-distance, high capacity and overhead line.

### SUMMARY

On the basis of this background, it is necessary to provide a method and system capable of simulating a diode clamped cascaded multi-level converter, based on the diode clamped cascaded multi-level converter.

A modeling method for a diode clamped cascaded multi-level converter is provided. The diode clamped cascaded multi-level converter includes at least two bridge arms. Each bridge arm includes a power module string made up of at least two cascaded power modules, and a bridge-arm reactor cascaded to the power module string. Each power module includes a first switching tube, a first diode, a second switching tube, a second diode, a third switching tube, a third diode, a fourth diode, a first capacitor and a second capacitor. The first switching tube and the first diode are coupled in an anti-parallel configuration. The second switching tube and the second diode are coupled in an anti-parallel configuration. The third switching tube and the third diode are coupled in an anti-parallel configuration. A cathode of the first diode is connected to a positive electrode of the first capacitor, and a negative electrode of the first capacitor is connected to a positive electrode of the second capacitor and a cathode of the fourth diode respectively. An anode of the fourth diode is connected to a cathode of the third diode, with a connection point as a negative output terminal of the power module. An anode of the third diode is connected to an anode of the second diode and a negative electrode of the second capacitor respectively. A cathode of the second diode is connected to an anode of the first diode, with a connection point as a positive output terminal of the power module. The modeling method includes:

transforming all first diodes of each bridge arm to be equivalent to a first auxiliary diode, transforming all second diodes of each bridge arm to be equivalent to a second auxiliary diode, transforming all third diodes of each bridge arm to be equivalent to a third auxiliary diode, and transforming all fourth diodes of each bridge arm to be equivalent to a fourth auxiliary diode;

transforming all first capacitors of each bridge arm to be equivalent to a first controlled voltage source, and transforming all second capacitors of each bridge arm to be equivalent to a second controlled voltage source; and

transforming the power module string of each bridge arm to be equivalent to an equivalent module, wherein the equivalent module includes a loss resistor and a composite equivalent model connected to the loss resistor in series, and the composite equivalent model includes the first auxiliary diode, the second auxiliary diode, the third auxiliary diode, the fourth auxiliary diode, the first controlled voltage source and the second controlled voltage source.

For the above modeling method for the diode clamped cascaded multi-level converter, since a plurality of components respectively placed at a same position in the corresponding power module of each bridge arm of the diode clamped cascaded multi-level converter can be equivalent to one component, the order of the node voltage equation can be reduced when simulating the diode clamped cascade multi-level converter in the PSCAD/EMTDC software, and the simulation efficiency can be improved, and cannot be reduced with the increasing of the power modules. By means of the modeling method, the requirements on engineering parameter design and control strategy validation of the VSC-HVDC involved a long-distance, high capacity and overhead line can be satisfied.

A modeling system for a diode clamped cascaded multi-level converter is provided. The diode clamped cascaded multi-level converter includes at least two bridge arms. Each bridge arm includes a power module string made up of at least two cascaded power modules, and a bridge-arm reactor cascaded to the power module string. Each power module includes a first switching tube, a first diode, a second switching tube, a second diode, a third switching tube, a third diode, a fourth diode, a first capacitor and a second capacitor. The first switching tube and the first diode are coupled in an anti-parallel configuration. The second switching tube and the second diode are coupled in an anti-parallel configuration. The third switching tube and the third diode are coupled in an anti-parallel configuration. A cathode of the first diode is connected to a positive electrode of the first capacitor, and a negative electrode of the first capacitor is connected to a positive electrode of the second capacitor and a cathode of the fourth diode respectively. An anode of the fourth diode is connected to a cathode of the third diode, with a connection point as a negative output terminal of the power module. An anode of the third diode is connected to an anode of the second diode and a negative electrode of the second capacitor respectively. A cathode of the second diode is connected to an anode of the first diode, with a connection point as a positive output terminal of the power module. The modeling system includes:

a diode equivalent module configured to transform all first diodes of each bridge arm to be equivalent to a first auxiliary diode, transform all second diodes of each bridge arm to be equivalent to a second auxiliary diode, transform all third diodes of each bridge arm to be equivalent to a third auxiliary diode, and transform all fourth diodes of each bridge arm to be equivalent to a fourth auxiliary diode;

a capacitor equivalent module configured to transform all first capacitors of each bridge arm to be equivalent to a first controlled voltage source, and transform all second capacitors of each bridge arm to be equivalent to a second controlled voltage source; and

a bridge-arm equivalent module configured to transform the power module string of each bridge arm to be equivalent to an equivalent module, wherein the equivalent module includes a loss resistor and a composite equivalent model connected to the loss resistor in series, and the composite equivalent model includes the first auxiliary diode, the second auxiliary diode, the third auxiliary diode, the fourth auxiliary diode, the first controlled voltage source and the second controlled voltage source.

For the above modeling system for the diode clamped cascaded multi-level converter, since a plurality of components respectively placed at same position in the corresponding power module of each bridge arm of the diode clamped cascaded multi-level converter can be equivalent to one component, the order of the node voltage equation can be reduced when simulating the diode clamped cascade multi-level converter under PSCAD/EMTDC software, and the simulation efficiency can be improved, and cannot be reduced with the increasing of the power modules. By means of the modeling method, the requirements on engineering parameter design and control policy validation of the VSC-HVDC involved a long-distance, high capacity and overhead line can be satisfied.

### BRIEF DESCRIPTION OF THE DRAWINGS

FIG. 1 is a schematic diagram illustrating a topological structure of a diode clamped cascaded multi-level converter.

FIG. 2 is a schematic diagram illustrating a topological structure of a power module of a diode clamped cascaded multi-level converter.

FIG. 3 is a flow diagram illustrating a modeling method for a diode clamped cascaded multi-level converter according to an embodiment of the present disclosure.

FIG. 4 is a schematic diagram illustrating a composite equivalent model of the model established by the modeling method of FIG. 3.

FIG. 5 is a schematic diagram illustrating a equivalent module of a power module string in the model established by the modeling method of FIG. 3.

FIG. 6 is a flowing diagram illustrating specific processes of one step of the modeling method of FIG. 3.

FIG. 7 is a structural schematic diagram illustrating a modeling system for a diode clamped cascaded multi-level converter according to one embodiment of the present disclosure.

FIG. 8 is structural schematic diagram illustrating one model of the modeling system of FIG. 7.

### DETAILED DESCRIPTION

In order to make it easier to be understood, the present disclosure will be described in further details with the accompanying drawings. The preferred embodiments of the present disclosure are illustrated in the drawings. The present disclosure can be realized through various modifications, not to limit the specific embodiments described herein. Conversely, the specific embodiments provided herein are merely to make the present disclosure be understood more clearly and comprehensively.

All of the technologies and the scientific terminologies used herein have the same implication with the ordinary meaning of those skilled in the art unless otherwise indicated. The terminologies used herein are merely to describe the specific embodiments of the present disclosure, but not to limit the present disclosure. The terms “or/and” used herein may include any one of the multiple corresponding items, or any combination thereof.

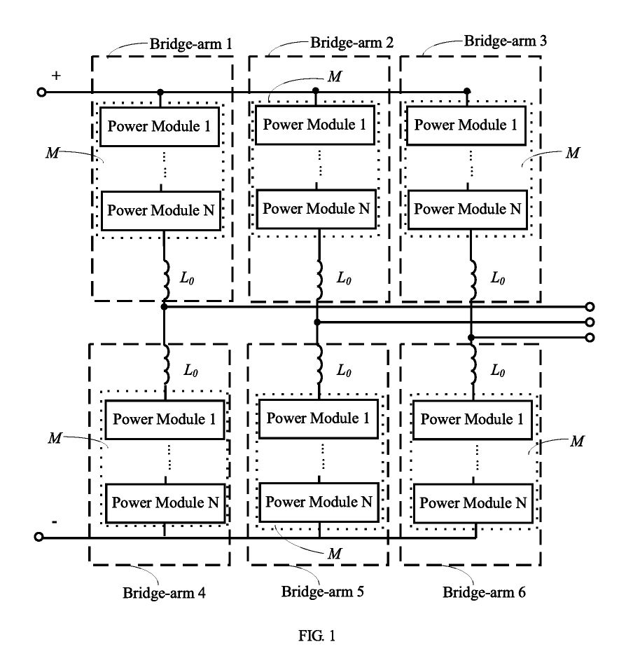

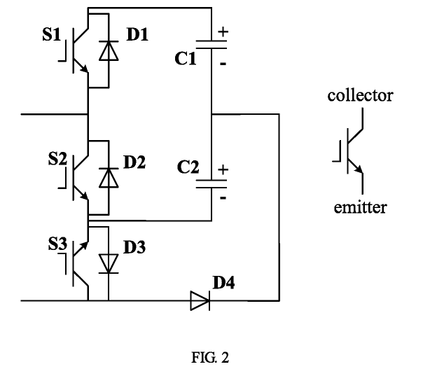

Referring to FIG. 1 and FIG. 2, a diode clamped cascaded multi-level converter may include at least two bridge arms. Each bridge arm may include a power module string M made up of at least two cascaded power modules, and a bridge-arm reactor L0 cascaded to the power module string M. Each power module may include a first switching tube S1, a first diode D1, a second switching tube S2, a second diode D2, a third switching tube S3, a third diode D3, a fourth diode D4, a first capacitor C1 and a second capacitor C2. The first switching tube S1 and the first diode D1 may be coupled in an anti-parallel configuration, that is, a collector electrode (C electrode) and an emitter electrode (E electrode) of the first switching tube S1 may be connected to a cathode of the first diode D1 and an anode of the first diode D1 respectively. The second switching tube S2 and the second diode D2 may be coupled in an anti-parallel configuration, and likewise, the third switching tube S3 and the third diode D3 may be coupled in an anti-parallel configuration. The cathode of the first diode D1 may be connected to a positive electrode of the first capacitor C1. A negative electrode of the first capacitor C1 may be connected to a positive electrode of the second capacitor C2 and a cathode of the fourth diode D4 respectively. An anode of the fourth diode D4 may be connected to a cathode of the third diode D3, with a connection point as a negative output terminal of the power module. An anode of the third diode D3 may be connected to an anode of the second diode D2 and a negative electrode of the second capacitor C2 respectively. A cathode of the second diode D2 may be connected to the anode of the first diode D1, with a connection point as a positive output terminal of the power module. Specifically, each power module may be a diode clamped power module with a same structure and function.

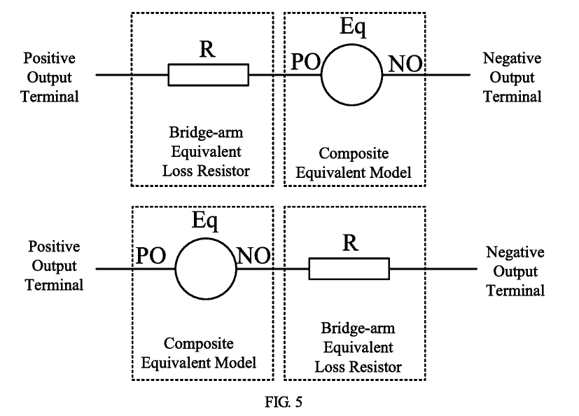

Referring to FIG. 3 to FIG. 5, a modeling method of a diode clamped cascaded multi-level converter is provided in this embodiment. The modeling method may include the following steps:

S100, transforming all first diodes D1 of each bridge arm to be equivalent to a first auxiliary diode SD1, transforming all second diodes D2 of each bridge arm to be equivalent to a second auxiliary diode SD2, transforming all third diodes D3 of each bridge arm to be equivalent to a third auxiliary diode SD3, and transforming all fourth diodes D4 of each bridge arm to be equivalent to a fourth auxiliary diode SD4, wherein each first diode D1 is positioned at a same position in its corresponding power module, each second diode D2 is positioned at a same position in its corresponding power module, each third diode D3 is positioned at a same position in its corresponding power module, and each fourth diode D4 is positioned at a same position in its corresponding power module;

S300, transforming all first capacitors C1 of each bridge arm to be equivalent to a first controlled voltage source V1, transforming all second capacitors C2 of each bridge arm to be equivalent to a second controlled voltage source V2, wherein each first capacitor C1 is positioned at a same position in its corresponding power module, and each second capacitor C2 is positioned at a same position in its corresponding power module; and

S500, transforming the power module string M of each bridge arm to be equivalent to a equivalent module, wherein the equivalent module includes a loss resistor and a composite equivalent model Eq connected to the loss resistor in series.

The composite equivalent model Eq may include the first auxiliary diode SD1, the second auxiliary diode SD2, the third auxiliary diode SD3, the fourth auxiliary diode SD4, the first controlled voltage source V1 and the second controlled voltage source V2.

For the above modeling method for the diode clamped cascaded multi-level converter, since a plurality of components respectively placed at a same position in the corresponding power module of each bridge arm of the diode clamped cascaded multi-level converter can be equivalent to one component, the order of the node voltage equation can be reduced when simulating the diode clamped cascade multi-level converter in the PSCAD/EMTDC software, and the simulation efficiency can be improved, and cannot be reduced with the increasing of the power modules. By means of the modeling method, the requirements on engineering parameter design and control policy validation of the VSC-HVDC involved a long-distance, high capacity and overhead line can be satisfied.

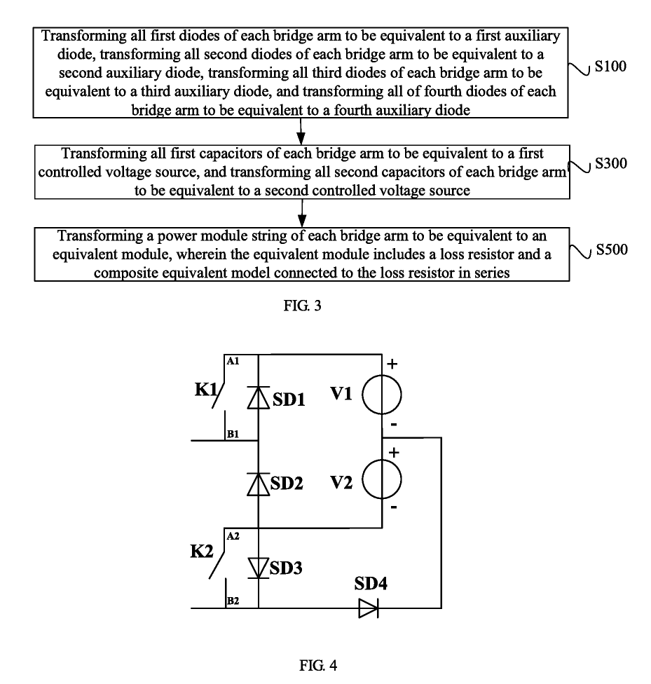

Continue to referring to FIG. 4, in one embodiment, the composite equivalent model Eq may further include a first auxiliary switch K1 and a second auxiliary switch K2. A first end A1 of the first auxiliary switch K1 may be connected to a cathode of the first auxiliary diode SD1 and a positive terminal of the first controlled voltage source V1 respectively. A negative terminal of the first controlled voltage source V1 may be connected to a positive terminal of the second controlled voltage source V2 and a cathode of the fourth auxiliary diode SD4 respectively. An anode of the fourth auxiliary diode SD4 may be connected to a cathode of the third auxiliary diode SD3 and a first end B2 of the second auxiliary switch K2 respectively, with a connection point as a negative output terminal NO of the composite equivalent model Eq. A second end A2 of the second auxiliary switch K2 may be connected to an anode of the third auxiliary diode SD3, a negative terminal of the second controlled voltage source V2 and an anode of the second auxiliary diode SD2 respectively. A cathode of the second auxiliary diode SD2 may be connected to a second end B1 of the first auxiliary switch K1 and an anode of the first auxiliary diode SD1 respectively, with a connection point as a positive output terminal PO of the composite equivalent model Eq.

When the diode clamped cascaded multi-level converter is in a latching mode, the first auxiliary switch K1 and the second auxiliary switch K2 are in an “off state”. The voltage value of the first controlled voltage source V1 may be contributed by all first capacitors C1 in all power modules of each corresponding bridge arm, while the voltage value of the second controlled voltage source V2 may be contributed by all second capacitors C2 in all power modules of each corresponding bridge arm.

When the diode clamped cascaded multi-level converter is in a normal operation mode, the first auxiliary switch K1 and the second auxiliary switch K2 are in an “on state”. The voltage value of the first controlled voltage source V1 may be contributed by the first capacitors C1 in the on-state power modules of each corresponding bridge arm, and the voltage value of the second controlled voltage source V2 may be contributed by the second capacitors C2 in the on-state power modules of each corresponding bridge arm.

The latching mode and the normal operation mode of the diode clamped cascade multi-level converter can be simulated by the model established by means of adopting the above modeling method, and the simulation effect has a better simulation precision as compared with the modeling method which is only capable of simulating one operation mode.

In one embodiment, the loss resistor R may be connected to the positive output terminal PO of the composite equivalent model Eq, such that a terminal of the loss resistor R not connected to the composite equivalent model Eq may be used as a positive output terminal of the equivalent module of the power module string M. The negative output terminal NO of the composite equivalent model Eq may be used as a negative output terminal of the equivalent module. In another embodiment, the loss resistor R may be connected to the negative output terminal NO of the composite equivalent model Eq, such that a terminal of the loss resistor R not connected to the composite equivalent model Eq may be used as the negative output terminal of the equivalent module of the power module string. The positive output terminal PO of the composite equivalent model Eq may be used as the positive output terminal of the equivalent module.

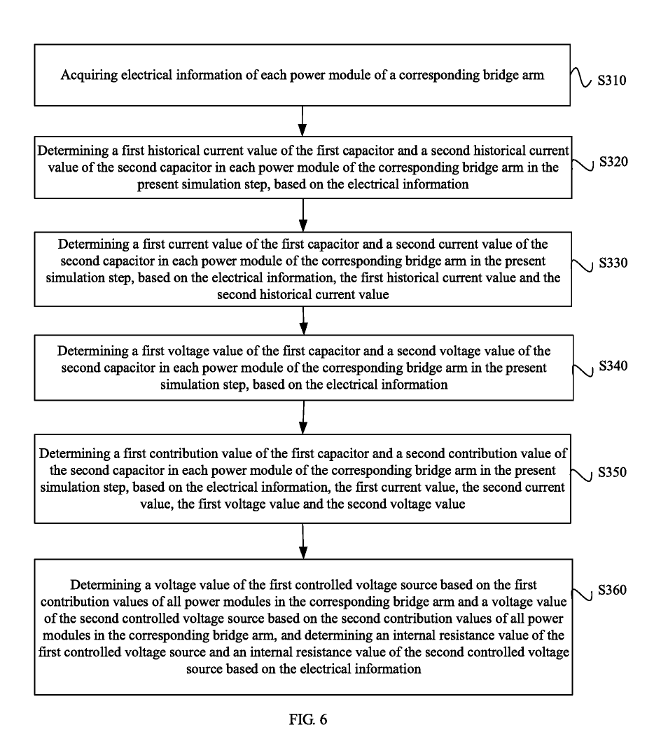

Referring to FIG. 6, in one embodiment, the step 300 may further include the following steps.

S310, acquiring electrical information of each power module of the corresponding bridge arm.

S320, determining a first historical current value of the first capacitor C1 and a second historical current value of the second capacitor C2 in each power module of the corresponding bridge arm in the present simulation step, based on the electrical information.

In one embodiment, the electrical information may include: a simulation step indicated by Δt; a capacitance value of the first capacitor and a capacitance value of the second capacitor, both being equivalent and indicated by C; a total number of the power modules, indicated by N; a serial number of one of the power modules, indicated by i; a first current value and a first voltage value of the first capacitor in a i^{th} power module of the corresponding bridge arm in a previous simulation step just before the present simulation step, indicated by I_{C1i}(t−Δt) and U_{C1i}(t−Δt) respectively; and a second current value and a second voltage value of the second capacitor in the i^{th} power module of the corresponding bridge arm in the previous simulation step, indicated by I_{C2i}(t−Δt) and U_{C2i}(t−Δt) respectively.

The equations for determining the first historical current value and the second historical current value are as follows:

I_{CD1i}(t)=−I_{C1i}(t−Δt)−U_{C1i}(t−Δt)/R_{CD} (1)

I_{CD2i}(t)=−I_{C2i}(t−Δt)−U_{C2i}(t−Δt)/R_{CD} (2)

where R_{CD}=Δt/C, I_{CD1i}(t) denotes the first historical current value, and I_{CD2i}(t) denotes the second historical current value.

S330, determining a first current value of the first capacitor C1 and a second current value of the second capacitor C2 in each power module of the corresponding bridge arm in the present simulation step, based on the electrical information, the first historical current value and the second historical current value.

In one embodiment, the electrical information may further include: a bridge-arm current value of the corresponding bridge arm in the present simulation step, indicated by I_{ARM}(t); a leakage resistance of the first capacitor and a leakage resistance of the second capacitor of each power module of the corresponding bridge arm, indicated by R_{P}; and a switching state of the first switching tube, a switching state of the second switching tube and a switching state of the third switching tube of the i^{th} power module of the corresponding bridge arm in the previous simulation step, indicated by S₁ᵢ(t−Δt), S₂ᵢ(t−Δt) and S₃ᵢ(t−Δt) respectively, wherein if the value of the switching state is 1, the corresponding switching tube is switched on, and if the value of the witching state is 0, the corresponding switching tube is switched off.

The equations for determining the first current value and the second current value are as follows:

$$\begin{matrix}{I}_{C 1 i} ( t ) = \{ \begin{matrix}\begin{matrix}{I}_{CD 1 i} ( t ) - \\ \frac{{I}_{CD 1 i} ( t )}{{R}_{P} + {R}_{CD}} {R}_{P}\end{matrix} & \begin{matrix}when {S}_{1 i} ( t - Δ t ) = 0 , \\ {S}_{21 i} ( t - Δ t ) = 1 , {S}_{3 i} ( t - Δ t ) = 1\end{matrix} \\ \begin{matrix}{I}_{CD 1 i} ( t ) - \\ \frac{{I}_{ARM} ( t ) - {I}_{CD 1 i} ( t )}{{R}_{P} + {R}_{CD}} {R}_{P}\end{matrix} & \begin{matrix}when {S}_{1 i} ( t - Δ t ) = 1 , \\ {S}_{21 i} ( t - Δ t ) = 0 , {S}_{3 i} ( t - Δ t ) = 1\end{matrix} \\ \begin{matrix}{I}_{CD 1 i} ( t ) - \\ \frac{{I}_{ARM} ( t ) - {I}_{CD 1 i} ( t )}{{R}_{P} + {R}_{CD}} {R}_{P}\end{matrix} & \begin{matrix}when {S}_{1 i} ( t - Δ t ) = 0 , \\ {S}_{21 i} ( t - Δ t ) = 0 , {S}_{3 i} ( t - Δ t ) = 0\end{matrix}\end{matrix} & ( 3 ) \\ {I}_{C 2 i} ( t ) = \{ \begin{matrix}\begin{matrix}{I}_{CD 2 i} ( t ) - \\ \frac{{I}_{CD 2 i} ( t )}{{R}_{P} + {R}_{CD}} {R}_{P}\end{matrix} & \begin{matrix}when {S}_{1 i} ( t - Δ t ) = 0 , \\ {S}_{21 i} ( t - Δ t ) = 1 , {S}_{3 i} ( t - Δ t ) = 1\end{matrix} \\ \begin{matrix}{I}_{CD 2 i} ( t ) - \\ \frac{{I}_{ARM} ( t ) - {I}_{CD 2 i} ( t )}{{R}_{P} + {R}_{CD}} {R}_{P}\end{matrix} & \begin{matrix}when {S}_{1 i} ( t - Δ t ) = 1 , \\ {S}_{21 i} ( t - Δ t ) = 0 , {S}_{3 i} ( t - Δ t ) = 1\end{matrix} \\ \begin{matrix}{I}_{CD 2 i} ( t ) - \\ \frac{{I}_{ARM} ( t ) - {I}_{CD 2 i} ( t )}{{R}_{P} + {R}_{CD}} {R}_{P}\end{matrix} & \begin{matrix}when {S}_{1 i} ( t - Δ t ) = 0 , \\ {S}_{21 i} ( t - Δ t ) = 0 , {S}_{3 i} ( t - Δ t ) = 0\end{matrix}\end{matrix} & ( 4 )\end{matrix}$$

where I_{C1i}(t) denotes the first current value, and I_{C2i}(t) denotes the second current value.

S340, determining a first voltage value of the first capacitor C1 and a second voltage value of the second capacitor C2 in each power module of the corresponding bridge arm in the present simulated step respectively, based on the electrical information.

In one embodiment, the equations for determining the first voltage value and the second voltage value are as follows:

U_{C1i}(t)=U_{C1i}(t−Δt)+R_{CD}[I_{C1i}(t)+I_{C1i}(t−Δt)] (5)

U_{C2i}(t)=U_{C2i}(t−Δt)+R_{CD}[I_{C2i}(t)+I_{C2i}(t−Δt)] (6)

where U_{C1i}(t) denotes the first voltage value, and U_{C2i}(t) denotes the second voltage value.

S350, determining a first contribution value of the first capacitor C1 and a second contribution value of the second capacitor C2 in each power module of the corresponding bridge arm in the present simulation step, based on the electrical information, the first current value, the second current value, the first voltage value and the second voltage value.

In one embodiment, the electrical information may further include a switching state of the first switching tube S1, a switching state of the second switching tube S2 and a switching state of the third switching tube S3 of the i^{th} power module of the corresponding bridge arm in the present simulation step, indicated by S₁ᵢ(t), S₂ᵢ(t) and S₃ᵢ(t) respectively. If the value of the switching state is 1, the corresponding switching tube is switched on, and if the value of the witching state is 0, the corresponding switching tube is switched off.

The equations for determining the first contribution value and the second contribution value are as follows:

$$\begin{matrix}{U}_{M 1 i} ( t ) = \{ \begin{matrix}0 & when {S}_{1 i} ( t ) = 0 , {S}_{21 i} ( t ) = 1 , {S}_{3 i} ( t ) = 1 \\ \frac{- {I}_{C 1 i} ( t ) {R}_{CD} - {U}_{C 1 i} ( t )}{{R}_{P} + {R}_{CD}} {R}_{P} & when {S}_{1 i} ( t ) = 1 , {S}_{21 i} ( t ) = 0 , {S}_{3 i} ( t ) = 1 \\ \frac{- {I}_{C 1 i} ( t ) {R}_{CD} - {U}_{C 1 i} ( t )}{{R}_{P} + {R}_{CD}} {R}_{P} & when {S}_{1 i} ( t ) = 0 , {S}_{21 i} ( t ) = 0 , {S}_{3 i} ( t ) = 0\end{matrix} & ( 7 ) \\ {U}_{M 1 i} ( t ) = \{ \begin{matrix}0 & when {S}_{1 i} ( t ) = 0 , {S}_{21 i} ( t ) = 1 , {S}_{3 i} ( t ) = 1 \\ \frac{- {I}_{C 1 i} ( t ) {R}_{CD} - {U}_{C 1 i} ( t )}{{R}_{P} + {R}_{CD}} {R}_{P} & when {S}_{1 i} ( t ) = 1 , {S}_{21 i} ( t ) = 0 , {S}_{3 i} ( t ) = 1 \\ \frac{- {I}_{C 1 i} ( t ) {R}_{CD} - {U}_{C 1 i} ( t )}{{R}_{P} + {R}_{CD}} {R}_{P} & when {S}_{1 i} ( t ) = 0 , {S}_{21 i} ( t ) = 0 , {S}_{3 i} ( t ) = 0\end{matrix} & ( 8 )\end{matrix}$$

where U_{M1i}(t) denotes the first contribution value, and U_{M2i}(t) denotes the second contribution value.

S360, determining a voltage value of the first controlled voltage source V1 based on the first contribution values of all power modules of the corresponding bridge arm, determining a voltage value of the second controlled voltage source V2 based on the second contribution values of all power modules of the corresponding bridge arm, and determining an internal resistance value of the first controlled voltage source V1 and an internal resistance value of the second controlled voltage source V2 based on the electrical information.

In one embodiment, the equations for determining the voltage values of the first controlled voltage source V1 and the second controlled voltage source V2 are as following:

$$\begin{matrix}{U}_{1} ( t ) = {\sum }_{i = 1}^{N} {U}_{M 1 i} ( t ) & ( 9 ) \\ {U}_{2} ( t ) = {\sum }_{i = 1}^{N} {U}_{M 2 i} ( t ) & ( 10 )\end{matrix}$$

where U₁(t) denotes the voltage value of the first controlled voltage source, and U₂(t) denotes the voltage value of the second controlled voltage source.

The equation for determining the internal resistance values of the first controlled voltage source V1 and the second controlled voltage source V2 is as follows:

$${R}_{1} ( t ) = {R}_{2} ( t ) = {\sum }_{i = 1}^{N} \frac{{R}_{P} {R}_{CD}}{{R}_{P} + {R}_{CD}} not [ {S}_{21 i} ( t ) ] \qquad ( 11 )$$

where R₁(t) denotes the resistance value of the first controlled voltage source V1, R₂(t) denotes the resistance value of the second controlled voltage source V2, and not indicates a logic negation operation which is a operation to reverse S₂₁ᵢ(t).

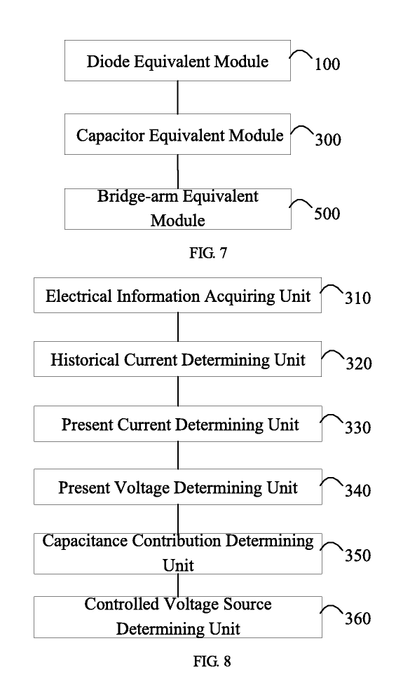

Referring to FIG. 7, a modeling system for a diode clamped cascade multi-level converter corresponding to the modeling method for the diode clamped cascade multi-level converter is also provided. The modeling system may include:

a diode equivalent module 100, configured to transform all first diodes D1 of each bridge arm to be equivalent to a first auxiliary diode SD1, transform all second diodes D2 of each bridge arm to be equivalent to a second auxiliary diode SD2, transform all third diodes D3 of each bridge arm to be equivalent to a third auxiliary diode SD3, and transform all fourth diodes D4 of each bridge arm to be equivalent to a fourth auxiliary diode SD4;

a capacitor equivalent module 300, configured to transform all first capacitors C1 of each bridge arm to be equivalent to a first controlled voltage source V1, and transform all second capacitors C2 of each bridge arm to be equivalent to a second controlled voltage source V2; and

a bridge-arm equivalent module 500, configured to transform a power module string M of each bridge arm to be equivalent to an equivalent module, wherein the equivalent module may include a loss resistor and a composite equivalent model Eq connected to the loss resistor in series, and the composite equivalent model Eq may include the first auxiliary diode SD1, the second auxiliary diode SD2, the third auxiliary diode SD3, the fourth auxiliary diode SD4, the first controlled voltage source V1 and the second controlled voltage source V2.

Continue to referring to FIG. 4, in one embodiment, the composite equivalent model Eq may further include a first auxiliary switch K1 and a second auxiliary switch K2. A first end A1 of the first auxiliary switch K1 may be connected to a cathode of the first auxiliary diode SD1 and a positive terminal of the first controlled voltage source V1 respectively. A negative terminal of the first controlled voltage source V1 may be connected to a positive terminal of the second controlled voltage source and a cathode of the fourth auxiliary diode SD4 respectively. An anode of the fourth auxiliary diode SD4 may be connected to a cathode of the third auxiliary diode SD3 and a first end B2 of the second auxiliary switch K2 respectively, with a shared connection point as a negative output terminal NO of the composite equivalent model Eq. A second end A2 of the second auxiliary switch K2 may be connected to an anode of the third auxiliary diode SD3, a negative terminal of the second controlled voltage source V2 and an anode of the auxiliary diode SD2 respectively. A cathode of the second auxiliary diode SD2 may be connected to a second end B1 of the first auxiliary switch K1 and an anode of the first auxiliary diode SD1 respectively, with a shared connection point as a positive output terminal PO of the composite equivalent model Eq.

Referring to FIG. 8, in one embodiment, the capacitor equivalent module 300 may include:

an electrical information acquiring unit 310, configured to acquire the electrical information of each power module of the corresponding bridge arm;

a historical current determining unit 320, configured to determine a first historical current value of the first capacitor C1 and a second historical current value of the second capacitor C2 in each power module of the corresponding bridge arm in the present simulation step based on the electrical information;

a present current determining unit 330, configured to determine the first current value of the first capacitor C1 and the second current value of the second capacitor C2 in each power module of the corresponding bridge arm in the present simulation step, based on the electrical information, the first historical current value and the second historical current value;

a present voltage determining unit 340, configured to determine a first voltage value of the first capacitor C1 and a second voltage value of the second capacitor C2 in each power module of the corresponding bridge arm based on the electrical information;

a capacitance contribution determining unit 350, configured to determine a first contribution value of the first capacitor C1 and a second contribution value of the second capacitor C2 in each power module of the corresponding bridge arm in present simulation step, based on the electrical information, the first current value, the second current value, the first voltage value and the second voltage value; and

a controlled voltage source determining unit 360, configured to determine a voltage value of the first controlled voltage source V1 based on the first contribution values of all power modules in the corresponding bridge arm, determine a voltage value of the second controlled voltage source V2 based on the second contribution values of all power modules in the corresponding bridge arm, and determine an internal resistance value of the first controlled voltage source V1 and an internal resistance value of the second controlled voltage source V2 based on the electrical information.

In the modeling system, the approach for acquiring the electrical information adopted by the electrical information acquiring unit 310, the approach for determining the first and second historical current values adopted by the historical current determining unit 320, the approach for determining the first and second current values adopted by the present current determining unit 330, the approach for determining the first and second voltage values adopted by the present voltage determining unit 340, the approach for determining the first and second contribution values adopted by the capacitance contribution determining unit 350, and the approach for determining the voltage values and internal resistance values of the first and second controlled voltage source adopted by the controlled voltage source determining unit 360 have been specifically described in the above embodiments of the modeling method, and are not repeatedly described herein.

For the above modeling system for the diode clamped cascaded multi-level converter, since a plurality of components respectively placed at same position in the corresponding power module of each bridge arm of the diode clamped cascaded multi-level converter can be equivalent to one component, the order of the node voltage equation can be reduced when simulating the diode clamped cascade multi-level converter under PSCAD/EMTDC software, and the simulation efficiency can be improved, and cannot be reduced with the increasing of the power modules. By means of the modeling method, the requirements on engineering parameter design and control policy validation of the VSC-HVDC involved a long-distance, high capacity and overhead line can be satisfied.

While various embodiments are discussed therein specifically, it will be understood that they are not intended to limit to these embodiments. It should be understood by those skilled in the art that various modifications and replacements may be made therein without departing from the theory of the present disclosure, which should also be seen in the scope of the present disclosure. The scope of the present disclosure should be defined by the appended claims.

What is claimed is:

1. A modeling method for a diode clamped cascaded multi-level converter, the diode clamped cascaded multi-level converter including at least two bridge arms, each bridge arm including a power module siring made up of at least two cascaded power modules and a bridge-arm reactor cascaded to the power module string, each power module including a first switching tube, a first diode, a second switching tube, a second diode, a third switching tube, a third diode, a fourth diode, a first capacitor and a second capacitor, the first switching tube and the first diode being coupled in an anti-parallel configuration, the second switching tube and the second diode being coupled in an anti-parallel configuration, and the third switching tube and the third diode being coupled in an anti-parallel configuration, a cathode of the first diode being connected to a positive electrode of the first capacitor, a negative electrode of the first capacitor being connected to a positive electrode of the second capacitor and a cathode of the fourth diode respectively, an anode of the fourth diode being connected to a cathode of the third diode with a connection point therebetween being a negative output terminal of the power module, an anode of the third diode being connected to an anode of the second diode and a negative electrode of the second capacitor respectively, a cathode of the second diode being connected to an anode of the first diode with a connection point therebetween being a positive output terminal of the power module, the modeling method comprising:
transforming all first diodes of each bridge arm to be equivalent to a first auxiliary diode, transforming all second diodes of each bridge arm to be equivalent to a second auxiliary diode, transforming all third diodes of each bridge arm to be equivalent to a third auxiliary diode, and transforming all fourth diodes of each bridge arm to be equivalent to a fourth auxiliary diode;
transforming all first capacitors of each bridge arm to be equivalent to a first controlled voltage source, and transforming all second capacitors of each bridge arm to be equivalent to a second controlled voltage source; and
transforming the power module string of each bridge arm to be equivalent to an equivalent module, wherein the equivalent module includes a loss resistor and a composite equivalent model connected to the loss resistor in series, and the composite equivalent model includes the first auxiliary diode, the second auxiliary diode, the third auxiliary diode, the fourth auxiliary diode, the first controlled voltage source and the second controlled voltage source.

2. The modeling method of claim 1, wherein the composite equivalent model further includes a first auxiliary switch and a second auxiliary switch; a first end of the first auxiliary switch is connected to a cathode of the first auxiliary diode and a positive terminal of the first controlled voltage source respectively; a negative terminal of the first controlled voltage source is connected to a positive terminal of the second controlled voltage source and a cathode of the fourth auxiliary diode respectively; an anode of the fourth auxiliary diode is connected to a cathode of the third auxiliary diode and a first end of the second auxiliary switch respectively, with a shared connection point as a negative output terminal of the composite equivalent model; a second end of the second auxiliary switch is connected to an anode of the third auxiliary diode, a negative terminal of the second controlled voltage source and an anode of the second auxiliary diode respectively; and a cathode of the second auxiliary diode is connected to a second end of the first auxiliary switch and an anode of the first auxiliary diode respectively, with a shared connection point as a positive output terminal of the composite equivalent model.

3. The modeling method of claim 2, wherein the loss resistor is connected to the positive output terminal of the composite equivalent model, or the loss resistor is connected to the negative output terminal of the composite equivalent model.

4. The modeling method of claim 2, wherein the transforming all first capacitors of each bridge arm to be equivalent to a first controlled voltage source, and transforming all second capacitors of each bridge arm to be equivalent to a second controlled voltage source include:
acquiring electrical information of each power module of a corresponding bridge arm;
determining a first historical current value of the first capacitor and a second historical current value of the second capacitor in each power module of the corresponding bridge arm in a present simulation step, based on the electrical information;
determining a first current value of the first capacitor and a second current value of the second capacitor in each power module of the corresponding bridge arm in the present simulation step, based on the electrical information, the first historical current value and the second historical current value;
determining a first voltage value of the first capacitor and a second voltage value of the second capacitor in each power module of the corresponding bridge arm in the present simulation step, based on the electrical information;
determining a first contribution value of the first capacitor and a second contribution value of the second capacitor in each power module of the corresponding bridge arm in the present simulation step, based on the electrical information, the first current value, the second current value, the first voltage value and the second voltage value; and
determining a voltage value of the first controlled voltage source based on first contribution values of all power modules of the corresponding bridge arm, determining a voltage value of the second controlled voltage source based on second contribution values of all power modules of the corresponding bridge arm, and determining an internal resistance value of the first controlled voltage source and an internal resistance value of the second controlled voltage source respectively based on the electrical information.

5. The modeling method of claim 4, wherein the electrical information includes:
a simulation step indicated by Δt;
a capacitance value of the first capacitor and a capacitance value of the second capacitor, both being equivalent and indicated by C;
a total number of the power modules, indicated by N;
a serial number of each of the power modules, indicated by i;
a first current value and a first voltage value of the first capacitor in a i^{th} power module of the corresponding bridge arm in a previous simulation step just before the present simulation step, indicated by I_{C1i}(t−Δt) and U_{C1i}(t−Δt) respectively; and
a second current value and a second voltage value of the second capacitor in the i^{th} power module of the corresponding bridge arm in the previous simulation step, indicated by I_{C2i}(t−Δt) and U_{C2i}(t−Δt) respectively; and
wherein equations for determining the first historical current value and the second historical current value are as follows:
I_{CD1i}(t)=−I_{C1i}(t−Δt)−U_{C1i}(t−Δt)/R_{CD}
I_{CD2i}(t)=−I_{C2i}(t−Δt)−U_{C2i}(t−Δt)/R_{CD}
wherein R_{CD}=Δt/C, I_{CD1i}(t) denotes the first historical current value, and I_{CD2i}(t) denotes the second historical current value.

6. The modeling method of claim 5, wherein the electrical information further includes:
a bridge-arm current value of the corresponding bridge arm in the present simulation step, indicated by I_{ARM}(t);
a leakage resistance of the first capacitor and a leakage resistance of the second capacitor of each power module of the corresponding bridge arm, indicated by R_{P}; and
a switching state of the first switching tube, a switching state of the second switching tube and a switching state of the third switching tube of the i^{th} power module of the corresponding bridge arm in the previous simulation step, indicated by S₁ᵢ(t−Δt), S₂ᵢ(t−Δt) and S₃ᵢ(t−Δt) respectively; and
wherein equations for determining the first current value and the second current value are as follows:
$${I}_{C 1 i} ( t ) = \{ \begin{matrix}{I}_{CD 1 i} ( t ) - \frac{{I}_{CD 1 i} ( t )}{{R}_{P} + {R}_{CD}} {R}_{P} & \begin{matrix}when {S}_{1 i} ( t - Δ t ) = 0 , \\ {S}_{21 i} ( t - Δ t ) = 1 , {S}_{3 i} ( t - Δ t ) = 1\end{matrix} \\ {I}_{CD 1 i} ( t ) - \frac{{I}_{ARM} ( t ) - {I}_{CD 1 i} ( t )}{{R}_{P} + {R}_{CD}} {R}_{P} & \begin{matrix}when {S}_{1 i} ( t - Δ t ) = 1 , \\ {S}_{21 i} ( t - Δ t ) = 0 , {S}_{3 i} ( t - Δ t ) = 1\end{matrix} \\ {I}_{CD 1 i} ( t ) - \frac{{I}_{ARM} ( t ) - {I}_{CD 1 i} ( t )}{{R}_{P} + {R}_{CD}} {R}_{P} & \begin{matrix}when {S}_{1 i} ( t - Δ t ) = 0 , \\ {S}_{21 i} ( t - Δ t ) = 0 , {S}_{3 i} ( t - Δ t ) = 0\end{matrix}\end{matrix} \\ {I}_{C 2 i} ( t ) = \{ \begin{matrix}{I}_{CD 2 i} ( t ) - \frac{{I}_{CD 2 i} ( t )}{{R}_{P} + {R}_{CD}} {R}_{P} & \begin{matrix}when {S}_{1 i} ( t - Δ t ) = 0 , \\ {S}_{21 i} ( t - Δ t ) = 1 , {S}_{3 i} ( t - Δ t ) = 1\end{matrix} \\ {I}_{CD 2 i} ( t ) - \frac{{I}_{ARM} ( t ) - {I}_{CD 2 i} ( t )}{{R}_{P} + {R}_{CD}} {R}_{P} & \begin{matrix}when {S}_{1 i} ( t - Δ t ) = 1 , \\ {S}_{21 i} ( t - Δ t ) = 0 , {S}_{3 i} ( t - Δ t ) = 1\end{matrix} \\ {I}_{CD 2 i} ( t ) - \frac{{I}_{ARM} ( t ) - {I}_{CD 2 i} ( t )}{{R}_{P} + {R}_{CD}} {R}_{P} & \begin{matrix}when {S}_{1 i} ( t - Δ t ) = 0 , \\ {S}_{21 i} ( t - Δ t ) = 0 , {S}_{3 i} ( t - Δ t ) = 0\end{matrix}\end{matrix}$$
wherein I_{C1i}(t) denotes the first current value, and I_{C2i}(t) denotes the second current value.

7. The modeling method of claim 6, wherein equations for determining the first voltage value and the second voltage value are as follows:
U_{C1i}(t)=U_{C1i}(t−Δt)+R_{CD}[I_{C1i}(t)+I_{C1i}(t−Δt)]
U_{C2i}(t)=U_{C2i}(t−Δt)+R_{CD}[I_{C2i}(t)+I_{C2i}(t−Δt)]
wherein U_{C1i}(t) denotes the first voltage value, and U_{C2i}(t) denotes the second voltage value.

8. The modeling method of claim 7, wherein the electrical information further includes:
a switching state of the first switching tube, a switching state of the second switching tube and a switching state of the third switching tube of the i^{th} power module of the corresponding bridge arm in the present simulation step, indicated by S₁ᵢ(t), S₂ᵢ(t) and S₃ᵢ(t) respectively; and
wherein equations for determining the first contribution value and the second contribution value are as follows:
$${U}_{M 1 i} ( t ) = \{ \begin{matrix}0 & when {S}_{1 i} ( t ) = 0 , {S}_{21 i} ( t ) = 1 , {S}_{3 i} ( t ) = 1 \\ \frac{- {I}_{C 1 i} ( t ) {R}_{CD} - {U}_{C 1 i} ( t )}{{R}_{P} + {R}_{CD}} {R}_{P} & when {S}_{1 i} ( t ) = 1 , {S}_{21 i} ( t ) = 0 , {S}_{3 i} ( t ) = 1 \\ \frac{- {I}_{C 1 i} ( t ) {R}_{CD} - {U}_{C 1 i} ( t )}{{R}_{P} + {R}_{CD}} {R}_{P} & when {S}_{1 i} ( t ) = 0 , {S}_{21 i} ( t ) = 0 , {S}_{3 i} ( t ) = 0\end{matrix} \\ {U}_{M 2 i} ( t ) = \{ \begin{matrix}0 & when {S}_{1 i} ( t ) = 0 , {S}_{21 i} ( t ) = 1 , {S}_{3 i} ( t ) = 1 \\ \frac{- {I}_{C 2 i} ( t ) {R}_{CD} - {U}_{C 2 i} ( t )}{{R}_{P} + {R}_{CD}} {R}_{P} & when {S}_{1 i} ( t ) = 1 , {S}_{21 i} ( t ) = 0 , {S}_{3 i} ( t ) = 1 \\ \frac{- {I}_{C 2 i} ( t ) {R}_{CD} - {U}_{C 2 i} ( t )}{{R}_{P} + {R}_{CD}} {R}_{P} & when {S}_{1 i} ( t ) = 0 , {S}_{21 i} ( t ) = 0 , {S}_{3 i} ( t ) = 0\end{matrix}$$
wherein U_{M1i}(t) denotes the first contribution value, and U_{M2i}(t) denotes the second contribution value.

9. The modeling method of claim 8, wherein equations for determining the voltage values of the first controlled voltage source and the second controlled voltage source are as follows:
$$\begin{matrix}{U}_{1} ( t ) = {\sum }_{i = 1}^{N} {U}_{M 1 i} ( t ) \\ {U}_{2} ( t ) = {\sum }_{i = 1}^{N} {U}_{M 2 i} ( t )\end{matrix}$$
wherein U₁(t) denotes the voltage value of the first controlled voltage source, and U₂(t) denotes the voltage value of the second controlled voltage source; and
wherein an equation for determining the internal resistance values of the first controlled voltage source and the second controlled voltage source is as follows:
$${R}_{1} ( t ) = {R}_{2} ( t ) = {\sum }_{i = 1}^{N} \frac{{R}_{P} {R}_{CD}}{{R}_{P} + {R}_{CD}} not [ {S}_{21 i} ( t ) ]$$
wherein, R₁(t) denotes the resistance value of the first controlled voltage source, R₂(t) denotes the resistance value of the second controlled voltage source, and “not” indicates a logic negation operation.

10. A modeling system for a diode clamped cascaded multi-level converter, the diode clamped cascaded multi-level converter including at least two bridge arms, each bridge arm including a power module siring made up of at least two cascaded power modules and a bridge-arm reactor cascaded to the power module string, each power module including a first switching tube, a first diode, a second switching tube, a second diode, a third switching tube, a third diode, a fourth diode, a first capacitor and a second capacitor, the first switching tube and the first diode being coupled in an anti-parallel configuration, the second switching tube and the second diode being coupled in an anti-parallel configuration, the third switching tube and the third diode being coupled in an anti-parallel configuration, a cathode of the first diode being connected to a positive electrode of the first capacitor, a negative electrode of the first capacitor being connected to a positive electrode of the second capacitor and a cathode of the fourth diode respectively, an anode of the fourth diode being connected to a cathode of the third diode with a connection point therebetween being a negative output terminal of the power module, an anode of the third diode being connected to an anode of the second diode and a negative electrode of the second capacitor respectively, a cathode of the second diode being connected to an anode of the first diode with a connection point therebetween being a positive output terminal of the power module, the modeling system comprising:
a diode equivalent module configured to transform all first diodes of each bridge arm to be equivalent to a first auxiliary diode, transform all second diodes of each bridge arm to be equivalent to a second auxiliary diode, transform all third diodes of each bridge arm to be equivalent to a third auxiliary diode, and transform all fourth diodes of each bridge arm to be equivalent to a fourth auxiliary diode;
a capacitor equivalent module configured to transform all first capacitors of each bridge arm to be equivalent to a first controlled voltage source, and transform all second capacitors of each bridge arm to be equivalent to a second controlled voltage source; and
a bridge-arm equivalent module configured to transform the power module string of each bridge arm to be equivalent to an equivalent module, wherein the equivalent module includes a loss resistor and a composite equivalent model connected to the loss resistor in series, and the composite equivalent model includes the first auxiliary diode, the second auxiliary diode, the third auxiliary diode, the fourth auxiliary diode, the first controlled voltage source and the second controlled voltage source.
